(19) United States
(12) Patent Application Publication
(10) Pub. No.: US 2023/0172788 A1
(43) Pub. Date: Jun. 8, 2023

(54) Axillary Crutch

(71) Applicant: Mobility Designed, Inc., Kansas City, MO (US)

(72) Inventors: Max Jefferies Younger, Roeland Park, KS (US); John Arnspiger, Fairway, KS (US)

(21) Appl. No.: 18/063,554

(22) Filed: Dec. 8, 2022

Related U.S. Application Data
(60) Provisional application No. 63/265,140, filed on Dec. 8, 2021.
(60) Provisional application No. 63/265,142, filed on Dec. 8, 2021.

(51) Int. Cl. A61H 3/02

(52) U.S. Cl. CPC A61H 3/02

(57) ABSTRACT

An axillary crutch includes a leg; a handle; and an axillary support secured atop the leg. The axillary support includes a lower support structure; an upper flexible layer; and a bladder disposed between the lower support structure and the layer.

### CROSS-REFERENCE TO RELATED APPLICATIONS

This application claims the benefit of priority of U.S. Provisional Patent Application No. 63/265,140, entitled “Axillary Crutch with Bladder” and U.S. Provisional Patent Application No. 63/265,142, entitled “Axillary Crutch with Cuff,” both filed Dec. 8, 2021, the disclosure of each of which is incorporated by reference herein in its entireties.

### FIELD OF THE INVENTION

The disclosure relates generally to the field of mobility devices. More specifically, the disclosure is directed to axillary crutches with biasing layers and/or cuffs.

### SUMMARY

The following presents a simplified summary of the invention in order to provide a basic understanding of some aspects of the invention. The summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein.

According to one embodiment, an axillary crutch includes a leg; a handle; and an axillary support secured atop the leg. The axillary support includes a lower support structure; an upper flexible layer; and a bladder disposed between the lower support structure and the layer.

According to another embodiment, an axillary crutch includes a leg; and an axillary support secured atop the leg, the axillary support comprising a selectively inflatable bladder.

In still another embodiment, an axillary crutch includes a leg; and an axillary support secured atop the leg. The axillary support includes a support layer; and a biasing layer coupled to the support layer.

### BRIEF DESCRIPTION OF THE DRAWINGS

FIG. 1 is a perspective view of axillary crutches according to embodiments of the invention in use.

FIG. 2 is a close-up perspective view of a cuff portion of an axillary crutch according to FIG. 1.

FIG. 3a is a close-up perspective view of a cuff portion of an axillary crutch according to another embodiment of the invention wherein the cuff it rotated 90 degrees from a standard position.

FIG. 3b is a close-up perspective view of the cuff portion of an axillary crutch of FIG. 3a wherein the cuff is in the standard position.

FIG. 3c is a close-up perspective view of the cuff portion of an axillary crutch of FIG. 3a wherein the cuff is rotated about 45 degrees from the standard position.

FIGS. 3d-3e are close-up perspective view of a cuff portion of an axillary crutch showing rotation of the cuff from the standard position.

FIG. 4 is a close-up exploded top view of the cuff portion of FIGS. 3a-c showing a rotating mechanism of the cuff.

FIG. 5 is a close-up exploded side perspective view of the cuff portion of FIGS. 3a-c showing the rotating mechanism of the cuff.

FIG. 6 is a perspective view of an axillary crutch with a novel underarm support in accordance with an embodiment of the invention.

FIG. 7 is a is a close-up perspective view of the underarm support portion of FIG. 6.

### DETAILED DESCRIPTION

Traditional crutches are designed with an underarm support that generally fits within the axillary region of a user's arm. The crutches typically include handles to help support the user's weight. Nevertheless, the underarm support puts pressure on the axillary region of the user's arm, often causing pain or even damage. It would be beneficial to reconfigure traditional crutches to include mechanisms that avoid causing pain or further injury to the user.

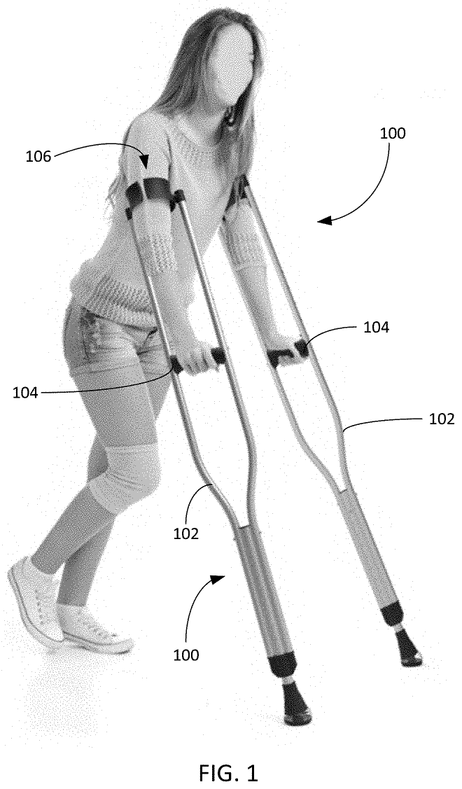

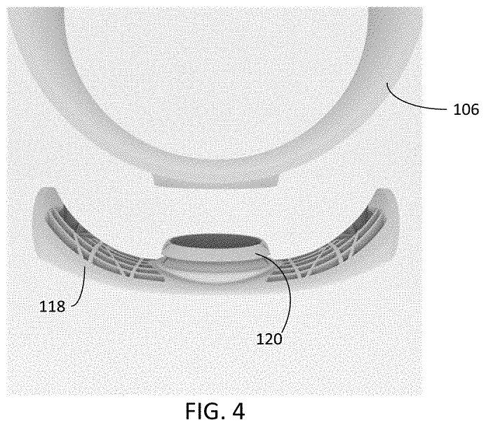

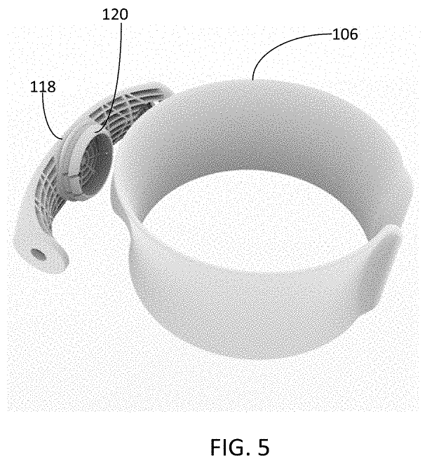

Referring first to FIGS. 1-5, according to an embodiment of the invention, an axillary crutch 100 includes a frame 102 having a handle 104. Contrary to traditional axillary crutches, the crutch 100 includes a cuff 106 in place of a traditional underarm support. The cuff 106 is designed to generally fit around the biceps and triceps region of the user's arm to stabilize the crutch 100 relative to the user's body.

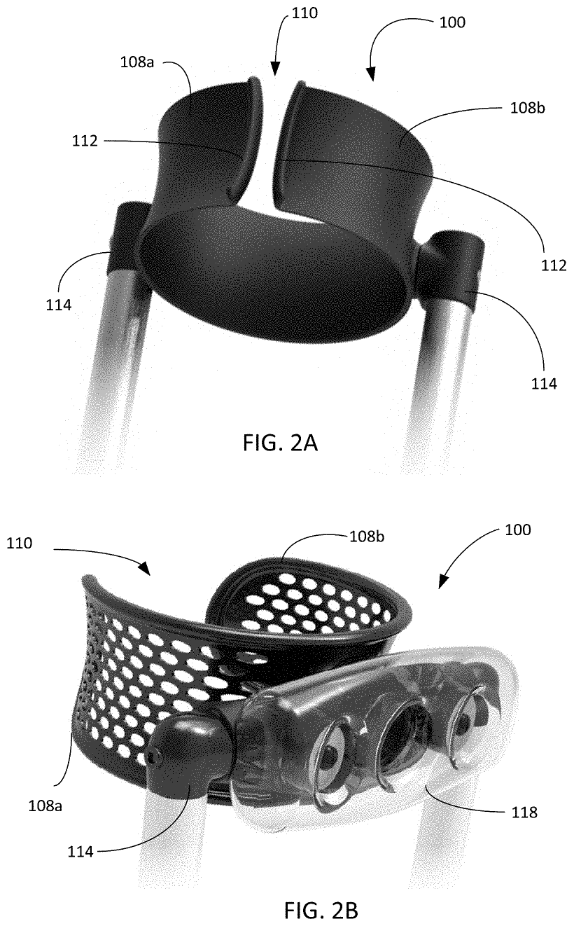

As shown in FIGS. 2-5, the cuff 106 may be generally “C” shaped such that the cuff 106 is open to one side, thus defining two “arms” 108a, 108b that define the opening 110. Preferably, but not necessarily, the opening 110 is positioned towards the outside of the crutch (and thus the user's arm). The arms 108a, 108b of the cuff 106 may include a lip 112 that rolls generally away from the cuff 106 to allow the user to more easily insert his or her arm into the cuff 106.

The cuff 106 may be formed of a flexible elastic material that allows the arms 108a, 108b of the cuff 106 to flex outwardly, e.g., when the user inserts his or her arm into the cuff 106. The arms 108a, 108b may then return to their respective original positions, e.g., around the user's arm. In some embodiments, the cuff 106 may be formed of a harder material, such as a metal, which may be coated in a, for example, rubberized coating. The metal cuff arms 108a, 108b may be configured to bend according to a general shape of a user's arm, and reshape according to a user's individual ergonomic requirements. In an embodiment, the cuff arms 108a, 108b may be hinged to allow the arms 108a, 108b to flex in one or both directions (e.g., in and/or out). The cuff 106 prevents the crutch 100 from falling away from the user's arm while the user is free to move his or her hands as desired without having hold of the handle 104.

The crutch 100 may be configured with two tubes forming the frame 102, as is shown in the figures. However, in embodiments, the crutch 100 may include a single leg, or any other crutch construction now known or later developed. Regardless of the construction of the frame 102, the cuff 106 is configured to attach to the frame 102 via attachment structure 114 (FIG. 2). The attachment structure 114 may slide over an/the end(s) of the frame 102 and may be secured with a screw, rivet, or other fastening mechanism.

In an embodiment, the attachment structure 114 includes one or more points of rotation about which the cuff 106 is configured to rotate. In embodiments, the crutch 100 may rotate along one or more axes. For example, the cuff 106 may be configured to rotate in a clockwise and/or counterclockwise motion, allowing for typical walking motion. Additionally, the cuff 106 may be configured to rotate in upwards and/or downwards motions to allow the user's arm to lift away from his or her body (e.g., as when completing a jumping jack). In other words, the cuff 106 may be configured such that the user has a full range of motion, while the crutch 100 remains in a generally vertical in-use position without the crutch cuff 106 becoming dislodged from the user's arm.

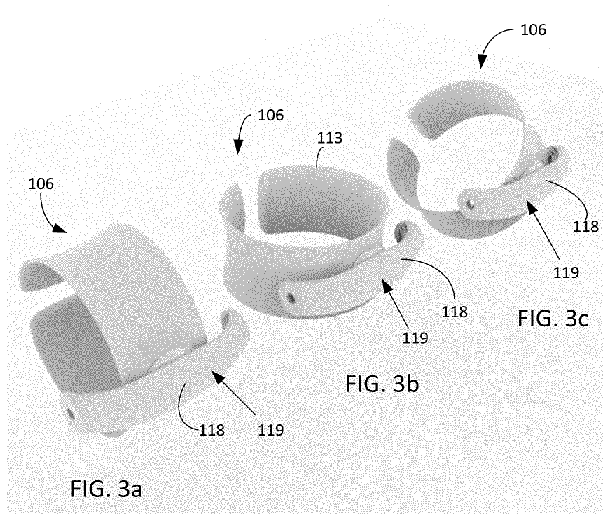

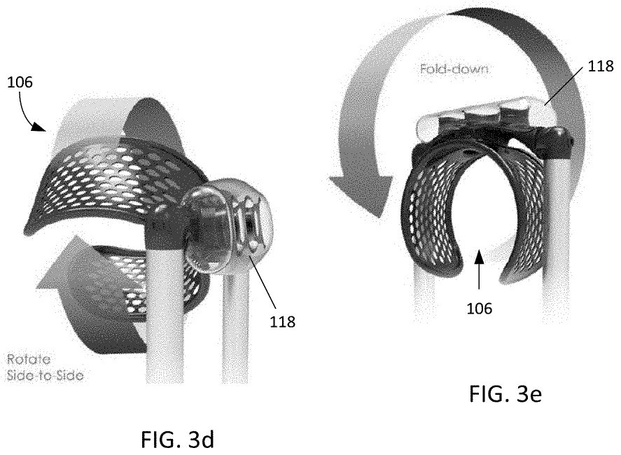

In some embodiments, the cuff 106 may include an auxiliary piece 118 that attaches to the frame 102 and the cuff 106 (see FIGS. 3-5). A translation component 120 may operably connect the cuff 106 to the auxiliary piece 118, and may allow the cuff 106 to slide back and forth, e.g., in a walking motion with the body, and/or may allow for movement in a disc-like motion. The translation component 120 may include a locking mechanism that may snap into an aligned position, e.g., using internal leaf springs. When unlocked, the translation component 120 thus allows the cuff 106 to swivel and slide relative to the auxiliary piece 118.

A face 119 of the auxiliary piece 118 may press against the user's upper torso region, near his or her ribs and remain stationary while the cuff 106 is permitted to move relative to the auxiliary piece 118. This allows the cuff 106 to move with the user without causing friction against the user's toros. The auxiliary piece 118 may include a bladder or foam piece for additional comfort. If a bladder is included, it may be selectively inflatable with any gas or fluid, including a gel.

The cuff 106 may be at least partially wrapped in a soft pad or cover to reduce friction between the cuff 106 and the user's arm. In embodiments, the cover may be an air bladder that is selectively inflatable with any gas or fluid, including a gel. The pad or cover may be selected to provide breathability, the cuff and/or the pad or cover may include holes that allow for airflow.

The crutch handle 104, which may be generally identical to a traditional axillary crutch handle, or specifically ergonomically designed for greater comfort and improved ease of use, may be the only true weight bearing mechanism of the crutch 100. As shown in the drawings, in embodiments, the handle 104 may be angled relative to the ground when the crutch 100 is in a vertical position. However, in embodiments, the cuff 106 may include a padded section on an upper lip 113 to provide some weight bearing support such that the user could push down on the cuff 106 if needed (e.g., in an emergency situation).

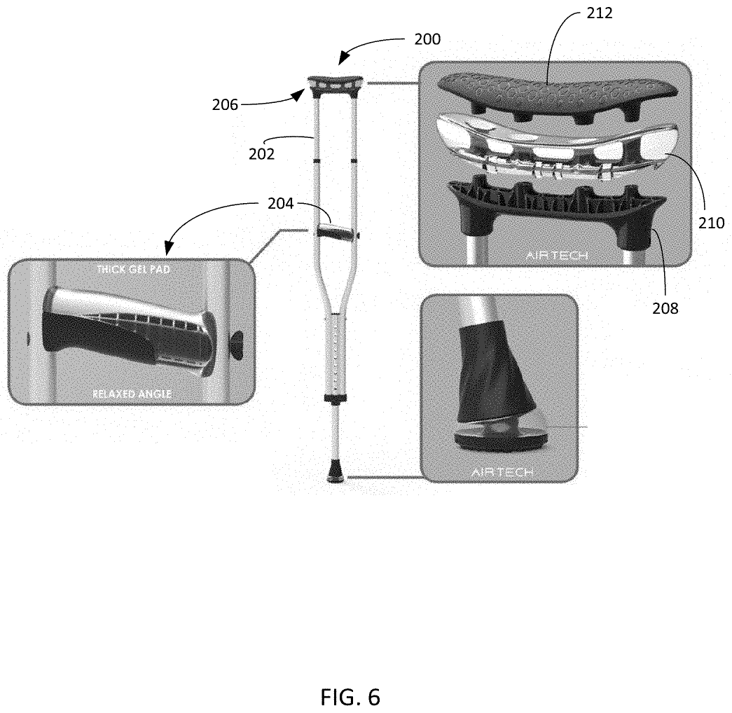

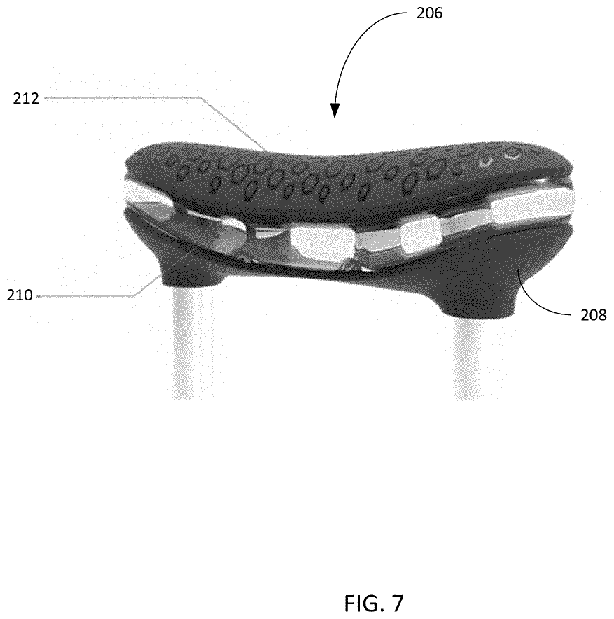

According to another embodiment of the invention, illustrated in FIGS. 6-7, rather than replacing the underarm support with a cuff as described above, an axillary crutch 200 operably coupled to an axillary support 206 that incorporates a biasing layer to support the weight of the user and provide superior cushioning ability as compared to traditional axillary crutches as will be described in greater detail below.

The axillary crutch 200 includes a frame 202 and a handle 204 as is standard for prior art axillary crutches. As shown in FIG. 6, the axillary crutch 200 includes a frame with two crutch tubes that attach to the axillary support 206. However, the axillary support 206 may be configured to connect to an axillary crutch having any configuration whether now known or later developed.

The handle 204 may be configured to have an ergonomic design that conforms more readily to the shape of a user's hand, making the handle 204 more comfortable for the user and potentially reducing injury to the hand and/or wrist. In embodiments, the handle 204 may include a selectively inflatable bladder. Where included, the handle bladder may be filled with any appropriate gas or fluid, including a gel.

With specific reference to FIG. 7, the axillary support 206 itself may include a bottom support layer 208, a flexible biasing layer 210, and a top layer 212. In general, the axillary support 206 may have an increased surface area as compared to traditional axillary crutches.

The bottom support 208 provides a structural foundation for the other components of the axillary support 206, namely, the biasing layer 210 and the top layer 212. More particularly, the bottom support 208 may keep the top layer 212 from overly deforming with use to the point that the crutch 200 can no longer be used. Accordingly, the bottom support 208 may be made of any material that is appropriate for providing such a foundation, such as a hard plastic or metal, for example.

The top layer 212 is a cushion layer that is soft and reduces friction between the axillary region of user's arm and the crutch 200. The top layer 212 may be, for example, a foam or a fabric layer. In embodiments, the top layer 212 includes a moisture wicking material. The top layer 212 may be configured to generally conform to the soft tissue of the axillary region of the user's arm to provide increased comfort to the user. The top layer 212 may be replaceable from user to user, particularly where the top layer material is such that it conforms to the user's body. Accordingly, the top layer 212 may temporarily attach to the bottom support 208 and the biasing layer 210, and be removed when the user is no longer using the crutch 200. A new user can place a new top layer 212 to the bottom support 208 and the biasing layer 210 before he or she begins using the crutch 200, similar perhaps to how an aftermarket bicycle cushion is attached to a bicycle seat. The top layer 212 may, in embodiments, be magnetically coupled to the biasing layer 212. In an embodiment, the top layer 212 may be mechanically coupled to the biasing layer 212, e.g., via hook-and-loop fastener, snaps, or any other mechanical coupling means now known or later developed. The replaceable top layer 212 may allow the crutch 200 to be used by multiple people without sacrificing the benefits of the top layer 212, and particularly the benefits that may be realized from a top layer 212 that conforms to the user's body. Furthermore, a replaceable top layer 212 may increase the usable life of the crutch 200.

Positioned between the bottom support 208 and the top layer 212, the biasing layer 210 is a flexible element that provides elastic support for the top layer 212 and allows energy to be absorbed as the user places his or her weight upon the crutch 200. The biasing layer 210 may be, for example, a bladder. The bladder 210 may be pressurized, and therefore, it may be permanently or releasably sealed such that pressure may be maintained. The bladder 210 may be filled with any appropriate gas or fluid, including gels. In embodiments, the biasing layer 210 may simply be a hollow enclosure between the bottom support 208 and the top layer 212 configured to act as a cushioned support by deforming, at least partially, under pressure. In still further embodiments, the biasing layer 210 may be a solid piece of flexible, elastic material, such as a foam or rubber. The biasing layer 210 may alternately be a non-elastic material (e.g., a hard plastic or metal) that includes an elastic coating, such as rubber, allowing some energy to be absorbed. According to yet another embodiment, the biasing layer 210 may include one or more biasing elements such as compression springs, coil springs, gas springs, flat springs, magnetic spring, or any other resilient device that allows energy from the top layer 212 (e.g., as the user utilizes the crutch 202) to be at least partially absorbed. The biasing layer 210 may, but need not, include structural columns as illustrated in FIG. 7.

The biasing layer 210 may be fashioned of a flexible substance, such as polyvinyl chloride, low density polyethylene (LDPE), or other material.

In embodiments, a bottom layer 208, biasing layer 210, and top layer 212 may not all be necessary. For example, the axillary support 206 may not include one or more of the top layer 212, the biasing layer 210, and/or the bottom support layer 208. More specifically, the axillary support may include a bottom layer 208 and a top layer 212 without an intervening biasing layer 210. Or, the biasing layer 210 may act also as a support for the top layer 212 such that the bottom layer 208 is unnecessary. Still further, the biasing layer 210 may be configured to dually function as a cushion layer such that top layer 212 is unnecessary. Thus, one or more layers 208, 210, 212 may be combined. In another example, the top layer 212 and the bottom support layer 208 may be formed of a single piece of material, with the biasing layer 210 optionally included, and if included, configured to fit between the top layer 212 and the bottom support layer 208.

Additionally, in embodiments, further layers may be provided. For example, a foam (or similar type) layer may be disposed between the bottom support layer 208 and the biasing layer 210. And an additional flexible layer may be disposed between the biasing layer 210 and the top layer 212. Each of the various layers may be adhered to the respective adjacent layer or layers.

In embodiments of the invention, the handle may be configured to have an ergonomic design that conforms more readily to the shape of a user's hand, making the handle more comfortable for the user and potentially reducing injury to the hand and/or wrist. In embodiments, the handle may also include a bladder. As with the axillary support bladder, the handle bladder may be filled with any gas or fluid, including a gel. As mentioned above, the handle may be angled relative to the ground when the crutch is in a generally vertical position. The handle may optionally include one or more silicone layers. More specifically, the handle may include a hard structural support and a soft cover, which may be, for example, a silicone or a foam.

Many different arrangements of the various components depicted, as well as components not shown, are possible without departing from the spirit and scope of the invention. Embodiments of the invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the invention. Further, it will be understood that certain features and subcombinations are of utility and may be employed within the scope of the disclosure. Further, various steps set forth herein may be carried out in orders that differ from those set forth herein without departing from the scope of the claimed methods. The specification shall not be restricted to the above embodiments. Any units of measurement provided herein are exemplary only and not meant to specifically define the dimensions of the system. Other dimensions may be appropriate or desirable.

1. An axillary crutch, comprising:
a leg;
a handle; and
an axillary support secured atop the leg, the axillary support comprising:
a lower support structure;
an upper flexible layer; and
a bladder disposed between the lower support structure and the layer.

2. The axillary crutch of claim 1, wherein the bladder is hollow.

3. The axillary crutch of claim 1, wherein the bladder is filled with a fluid.

4. The axillary crutch of claim 1, wherein the top layer is selected from the group consisting of foam and fabric.

5. The axillary crutch of claim 1, wherein the handle is angled.

6. The axillary crutch of claim 1, wherein the handle comprises a selectively inflatable bladder.

7. The axillary crutch of claim 1, wherein the upper flexible layer is selectively detachable from the bladder.

8. An axillary crutch, comprising:
a leg; and
an axillary support secured atop the leg, the axillary support comprising a selectively inflatable bladder.

9. The axillary crutch of claim 8, wherein the bladder is selectively filled with a gas or a fluid.

10. An axillary crutch, comprising:
a leg; and
an axillary support secured atop the leg, the axillary support comprising:
a support layer; and
a biasing layer coupled to the support layer.

11. The axillary crutch of claim 10, wherein the biasing layer comprises a selectively inflatable bladder.

12. The axillary crutch of claim 11, wherein the selectively inflatable bladder is filled with a gas or a fluid.

13. The axillary crutch of claim 12, further comprising an upper layer at least partially covering the biasing layer.

14. The axillary crutch of claim 13, wherein the upper layer comprises a material selected from the group consisting of a foam, a silicone, and a fabric.

15. The axillary crutch of claim 10, wherein the biasing layer comprises one or more biasing members selected from the group consisting of compression springs, coil springs, gas springs, flat springs, and magnetic springs.

16. The axillary crutch of claim 10, wherein the biasing layer comprises an elastic material configured to temporarily deform under pressure from a user, and wherein the biasing layer returns to an initial position when pressure from the user is removed.

17. The axillary crutch of claim 10, further comprising an upper layer coupled to and at least partially covering the biasing layer.

18. The axillary crutch of claim 17, wherein the upper layer comprises a cushion layer.

19. The axillary crutch of claim 18, wherein the cushion layer comprises a material selected from the group consisting of a foam and a fabric.

20. The axillary crutch of claim 17, wherein the upper layer is selectively detachable from the biasing layer.
